(19) United States
(12) Patent Application Publication
(10) Pub. No.: US 2025/0251002 A1
(43) Pub. Date: Aug. 7, 2025

(54) TELESCOPIC ROD AND TELESCOPIC STRUCTURE

(71) Applicant: Shandong Yijiale Smart Home Technology Co., Ltd., Yantai City (CN)

(72) Inventor: Zengjie Yu, Longkou City (CN)

(21) Appl. No.: 19/190,518

(22) Filed: Apr. 25, 2025

(30) Foreign Application Priority Data
Jun. 19, 2024 (CN) 202421410016.5

(51) Int. Cl. F16B 7/14; F16B 7/16

(52) U.S. Cl. CPC F16B 7/1463; F16B 7/16

(57) ABSTRACT

A telescopic rod and a telescopic structure are provided. The telescopic rod includes an inner tube and an outer tube, an end portion of the inner tube extending into the outer tube is used as an extension end and is provided with a limiting portion, a bottom portion of the limiting portion is connected to the extension end, an outer diameter of an outer peripheral wall of the limiting portion gradually increases from the bottom portion to a top portion thereof, a positioning member is slidably connected with an elastic portion, the elastic portion has elastic expansion members, and the elastic expansion members form static friction with an inner wall of the outer tube, which result in a simple structure, convenient operation and very stable locking.

### TECHNICAL FIELD

The present invention relates to the technical field of telescopic rods, and particularly to a telescopic rod and a telescopic structure.

### BACKGROUND

Manual telescopic rods have a wide range of applications, such as curtain rods and door curtain rods. Two rod-shaped members are nested with each other and form relative sliding, and a locking mechanism is provided between the two rod-shaped members. When the two rod-shaped members are mutually telescoped or stretched, they are locked by a locking mechanism to achieve telescopic function of the telescopic rod. For example, Chinese invention patent No. CN208951048U discloses a locking structure for a telescopic rod body, where a connection locking sleeve is provided between an outer tube and an inner tube, and bolts are mounted to realize locking. This structure is complex, and the external locking structure affects the integrity of the telescopic rod.

### SUMMARY

An object of the present invention is to provide a telescopic rod and a telescopic structure to address the above technical deficiencies.

The present invention provides a telescopic rod which includes an inner tube and an outer tube nested with each other, where an end portion of the inner tube extending into the outer tube is used as an extension end, the extension end is provided with a limiting portion, a bottom portion of the limiting portion is connected to the extension end, a top portion of the limiting portion is provided with a positioning member, an outer diameter of an outer peripheral wall of the limiting portion gradually decreases from the bottom portion to the top portion, and the positioning member is slidably connected with an elastic portion, so that the elastic portion can reciprocate along the positioning member in the same axial direction as the inner tube; the elastic portion has elastic expansion members, and the elastic expansion members form static friction with an inner wall of the outer tube; when the inner tube and the outer tube are rotated relative to each other, the static friction between the outer tube and the elastic expansion members drives the elastic portion to move along the positioning member towards the limiting portion, and the elastic expansion members and the outer peripheral wall of the limiting portion fit to each other, so that as the elastic portion moves towards the limiting portion, the elastic expansion members move from the top portion of the limiting portion to the bottom portion thereof, and the limiting portion gradually expands the elastic expansion members, so that the elastic expansion members are tightly abutted against the inner wall of the outer tube; and at this point, the inner tube and outer tubes are in a mutually locked state, and no relative axial displacement occurs between the inner tube and the outer tube; and when the inner tube and the outer tube are rotated in opposite directions relative to each other, the outer tube drives the elastic portion to move away from the limiting portion along the positioning member, so that the elastic expansion members of the elastic portion move from the bottom portion of the limiting portion to the top portion thereof, the elastic expansion members gradually retract, the elastic expansion members and the inner wall of the outer tube are released from the tight abutting state, and at this time, the outer tube and the inner tube are in a mutually unlocked state.

The present invention also provides a telescopic structure which includes an inner tube and an outer tube nested with each other, where an end portion of the inner tube extending into the outer tube is used as an extension end, the extension end is provided with a limiting portion, a positioning member is provided between a bottom portion of the limiting portion and the extension end, an outer wall of the limiting portion gradually increases from the bottom portion to a top portion thereof, and the positioning member is slidably connected with an elastic portion, so that the elastic portion can reciprocate along the positioning member in the same axial direction as the inner tube, and the limiting portion forms a limit to the elastic portion to prevent the elastic portion from detaching from the limiting portion; the elastic portion has elastic expansion members, and the elastic expansion members form static friction with an inner wall of the outer tube; when the inner tube and the outer tube are rotated relative to each other, the elastic expansion members move along the positioning member towards the limiting portion due to the static friction; the elastic expansion members move from the top portion of the limiting portion to the bottom portion thereof along an outer peripheral wall of the limiting portion, and the limiting portion gradually expands the elastic expansion members, so that the elastic expansion members are tightly abutted against the inner wall of the outer tube; and at this point, the inner tube and outer tubes are in a mutually locked state, and no relative axial displacement occurs between the inner tube and the outer tube; and when the inner tube and the outer tube are rotated in opposite directions relative to each other, the outer tube drives the elastic portion to move away from the limiting portion along the positioning member, so that the elastic expansion members of the elastic portion move from the bottom portion of the limiting portion to the top portion thereof, the elastic expansion members gradually retract, the elastic expansion members and the inner wall of the outer tube are released from the tight abutting state, and at this time, the outer tube and the inner tube are in a mutually unlocked state.

The present invention has the following technical effects: an end portion of the inner tube extending into the outer tube is provided with a limiting portion and a positioning member, the limiting portion is connected to the end portion of the inner tube, and the positioning member is connected to a top portion of the limiting portion, or the positioning member is connected to the end portion of the inner tube, and the limiting portion is connected to the top portion of the positioning member; an outer diameter of an outer peripheral wall of the limiting portion gradually increases from the bottom portion to the top portion; the positioning member is a threaded post, an elastic portion is threadedly connected to the threaded post, and the elastic portion has elastic expansion members; static friction is formed between the elastic expansion members and an inner wall of the outer tube; when the outer tube is rotated, the outer tube drives the elastic expansion members to rotate, thereby causing the elastic portion to rotate, and the elastic portion reciprocates axially along the positioning member namely the threaded post; and when the elastic portion moves towards the limiting portion, the elastic expansion members contact an outer wall of the limiting portion and moves from the top portion of the limiting portion to the bottom portion of the limiting portion along the limiting portion, and since the outer diameter of the outer peripheral wall of the limiting portion gradually increases from the bottom portion to the top portion, the elastic expansion members are gradually expanded, so that the elastic expansion members are tightly abutted against the inner wall of the outer tube, and at this time, a tight fit is formed between the elastic portion and the outer tube. Therefore, the outer tube and the inner tube are in a locked state, and when unlocking is needed, the outer tube is rotated in the opposite direction, the outer tube drives the elastic portion to rotate, and the elastic portion moves from the bottom portion of the limiting portion to the top portion thereof along the positioning member, at this time, the elastic expansion members gradually retract, and the elastic expansion members and the inner wall of the outer tube are released from the tight abutting state. Therefore, the inner tube and the outer tube can be locked at any position after telescoping and stretching, which results in a simple structure, avoids excessive processing of the tubes, lead to very stable locking.

### BRIEF DESCRIPTION OF THE DRAWINGS

FIG. 1 is an overall structural diagram of the present invention;

FIG. 2 is an overall structural exploded view of Embodiment 1 of the present invention;

FIG. 3 is an exploded view of an elastic portion;

FIG. 4 is an overall view of the elastic portion;

FIG. 5 is a structural diagram of an elastic portion and a limiting portion in an unlocked state according to Embodiment 1;

FIG. 6 is a structural diagram of the elastic portion and the limiting portion in a locked state according to Embodiment 1;

FIG. 7 is an overall structural exploded view of Embodiment 2 of the present invention; and

FIG. 8 is a structural diagram of an elastic portion and a limiting portion in an unlocked state according to Embodiment 2.

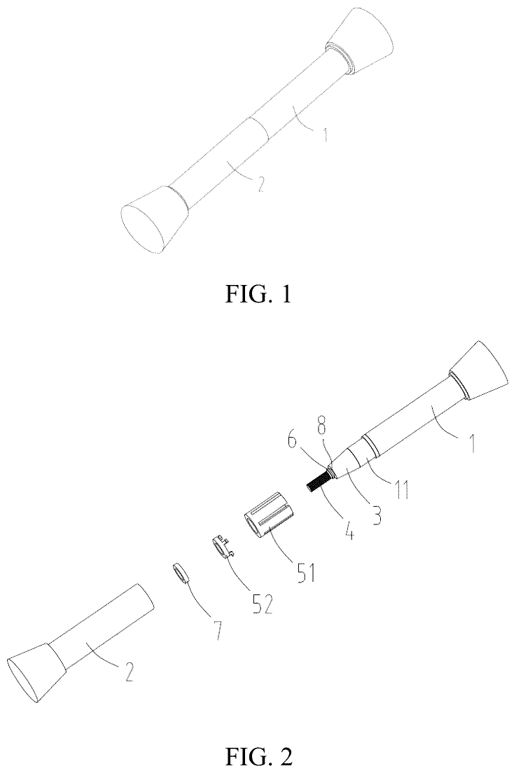

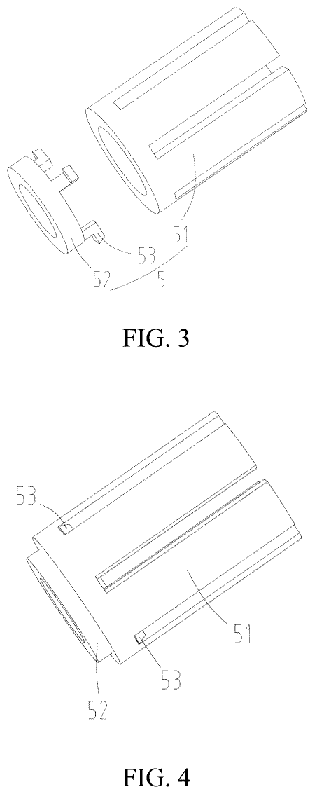

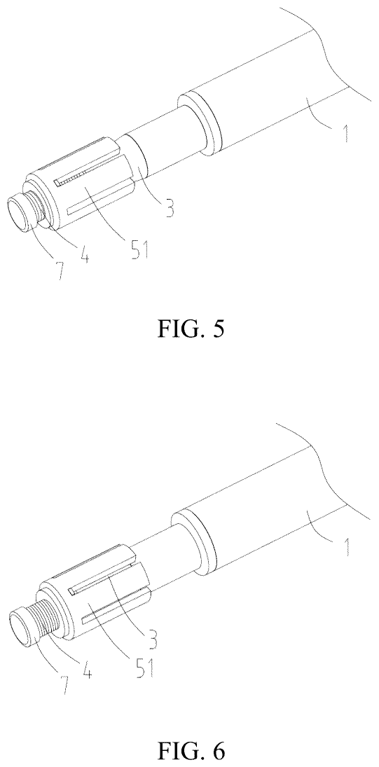

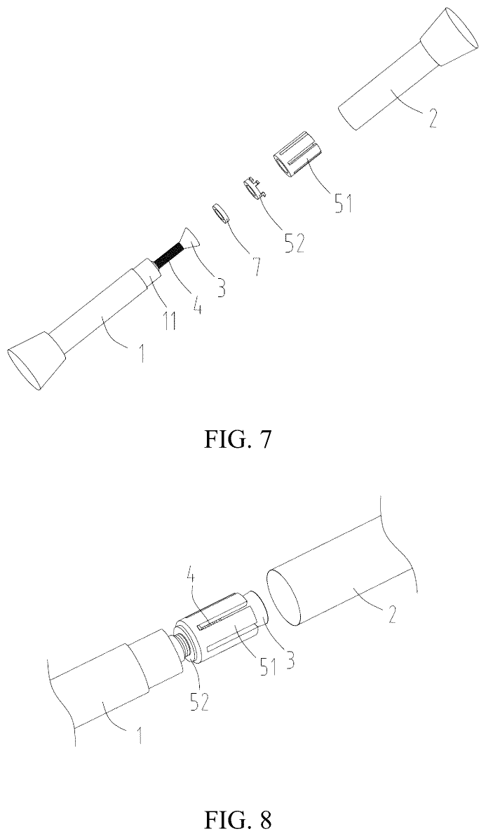

Description of reference numerals in the drawings: 1. inner tube; 11. extension end; 2. outer tube; 3. limiting portion; 4. positioning member; 5. elastic portion; 51. elastic expansion member; 52. base; 53. snap-in block; 6. first limiting ring; 7. second limiting ring; and 8. through hole.

### DESCRIPTION OF THE EMBODIMENTS

The technical solutions in the embodiments of the present invention will be clearly and completely described below in conjunction with the accompanying drawings in the embodiments of the present invention. Obviously, the described embodiments are only part but not all of the embodiments of the present invention. All other embodiments obtained by a person of ordinary skill in the art based on the embodiments of the present invention without creative efforts shall fall within the protection scope of the present invention.

### Embodiment 1

The present invention provides a telescopic rod which includes an inner tube 1 and an outer tube 2 nested with each other, that is, one end of the inner tube 1 is inserted into the outer tube 2 as an extension end 11, the extension end 11 of the inner tube 1 is provided with a limiting portion 3, a bottom portion of the limiting portion 3 is connected to the extension end 11, and a top portion thereof is provided with a positioning member 4, an outer diameter of an outer peripheral wall of the limiting portion 3 gradually decreases from the bottom portion to the top portion. In the present embodiment, the limiting portion 3 is a circular truncated cone structure, and the positioning member 4 is slidably connected with an elastic portion 5, so that the elastic portion 5 can reciprocate along the positioning member 4 in the same axial direction as the inner tube 1; and the elastic portion 5 has elastic expansion members 51, the elastic expansion members 51 form static friction with an inner wall of the outer tube 2, that is, when the outer tube 2 is rotated or axially moved, the outer tube 2 can drive the elastic portion 5 to rotate or move axially, that is, the outer tube 2 and the elastic portion 5 move synchronously.

When the inner tube 1 and the outer tube 2 are rotated relative to each other, the static friction between the outer tube 2 and the elastic expansion members 51 drives the elastic portion 5 to move along the positioning member 4 towards the limiting portion 3, the elastic expansion members 51 and the outer peripheral wall of the limiting portion 3 fit to each other, so that as the elastic portion 5 moves towards the limiting portion 3, the elastic expansion members 51 move from the bottom portion of the limiting portion 3 to the top portion thereof. The outer diameter of the outer peripheral wall of the limiting portion 3 gradually increases from the bottom portion to the top portion.

As the elastic portion 5 continues to move axially, the limiting portion 3 gradually expands the elastic expansion members 51 until outer walls of the elastic expansion members 51 are tightly abutted against the inner wall of the outer tube 2, so that a tight fit is formed between the elastic expansion members 51 and the inner wall of the outer tube 2, at this time, the inner tube 1 and the outer tube 2 are in a mutually locked state, and no relative axial displacement occurs between the inner tube 1 and the outer tube 2.

When the inner tube 1 and the outer tube 2 are rotated in opposite directions relative to each other, the outer tube 2 drives the elastic portion 5 to move away from the limiting portion 3 along the positioning member 4, so that the elastic expansion members 51 of the elastic portion 5 move from the bottom portion of the limiting portion 3 to the top portion thereof, the elastic expansion members 51 gradually retract due to its own elasticity, and the elastic expansion members 51 and the inner wall of the outer tube 2 are released from the tight fit state; at this time, the outer tube 2 and the inner tube 1 are in a mutually unlocked state, therefore, the outer tube 2 and the inner tube 1 can be axially moved to each other after unlocking, so that the length of the telescopic rod can be adjusted; when the length is adjusted, by rotating the outer tube 2 or the inner tube 1, the outer tube 2 drives the elastic portion 5 to move along the positioning member 4 to the limiting portion 3 by means of static friction, so that the elastic expansion members 51 of the elastic portion 5 are gradually expanded along the limiting portion 3, a tight fit is formed between the elastic expansion members 51 and the inner wall of the outer tube 2; and at this time, the inner tube 1 and the outer tube 2 are in a mutually locked state, that is, length adjustment of the telescopic rod is completed.

Specifically, the elastic portion 5 includes a base 52 and the elastic expansion members 51 connected to the base 52, the base 52 is slidably connected to the positioning member 4, and the base 52 and the elastic expansion members 51 can be an integral structure or separated structures. In the present embodiment, the base 52 and the elastic expansion members 51 are separated structures, the base 52 is an annular seat structure, the elastic expansion members 51 are long-strip block with a certain elastic deformation ability, a plurality of long-strip blocks are spaced and evenly and oppositely distributed around the base 52, and outer walls of the long-strip blocks have a shape adapted to the inner wall of the outer tube 2; a plurality of spaced and evenly distributed snap-in blocks 53 are provided around the base 52, a connection is formed among bottom portions of the plurality of elastic expansion members 51, that is, bottom portion of the plurality of elastic expansion members 51 are also an annular seat structure; and a gap is formed between two adjacent elastic expansion members 51, and the elastic expansion members 51 extend axially along the outer tube 2. In the present embodiment, the plurality of elastic expansion members 51 form a cylindrical structure, the base 52 is mounted from one end formed by the plurality of elastic expansion members 51 to the bottom portions of the elastic expansion members 51, and the snap-in blocks 53 of the base 52 are snapped into the gap between the corresponding two adjacent elastic expansion members 51 to form a limit, so that a rotation limit is formed between the base 52 and the plurality of elastic expansion members 51, so that the elastic portion 5 can drive the base 52 to rotate.

The positioning member 4 is a threaded post, and a threaded hole in slide fit with the threaded post is provided in the center of the base 52, so that the base 52 can axially reciprocate along the threaded post by rotation, and the base 52 drives the elastic expansion members 51 to axially reciprocate.

In addition, a through hole 8 is provided in the center of the limiting portion 3, the limiting portion 3 is sleeved on the threaded post through the through hole 8, and the positioning member 4 is provided with a first limiting ring 6 at the through hole 8. In the present embodiment, the first limiting ring 6 is threadedly connected to the threaded post to form a limit to prevent the limiting portion 3 and the positioning member 4 from detaching from each other.

A top end of the positioning member 4 is provided with a second limiting ring 7 to prevent the base 52 from detaching from the positioning member 4, and the first limiting ring 6 and the second limiting ring 7 may be a nut or other limiting component threadedly connected with the positioning member 4.

In addition, the elastic expansion members 51 are made of plastic, so that the elastic expansion members 51 have elastic deformation ability, and the friction with the inner wall of the outer tube 2 does not generate noise. The limiting portion 3 is also made of plastic, so that the elastic expansion members 51 are not easily worn when coming into contact with the outer peripheral wall of the limiting portion 3, and generate no noise.

### Embodiment 2

The present invention also provides a telescopic structure which has a basic structure the same as the telescopic rod. In the telescopic structure, the limiting portion 3 is connected to the end portion of the inner tube 1, the positioning member 4 is connected to the top portion of the limiting portion 3, the base 52 of the elastic portion 5 is sleeved on the positioning member 4, that is, the base 52 of the elastic portion 5 is sleeved on the threaded post and form a threaded connection with the threaded post, the plurality of elastic expansion members 51 of the elastic portion 5 are open towards the end portion of the inner tube 1, so that the elastic portion 5 is axially moved relative to the end portion of the inner tube 1 as the positioning member 4 rotates. However, in the present embodiment, the positioning member 4 is connected to the end portion of the inner tube 1, the limiting portion 3 is connected to a top portion of the positioning member 4, the base 52 of the elastic portion 5 is sleeved on the positioning member 4, the base 52 faces the end portion of the inner tube 1, and the plurality of elastic expansion members 51 of the elastic portion 5 are open towards the direction in which the limiting portion 3 and the outer tube 2 are located, that is, axial movement directions of the elastic expansion members 51 are reverse in the two embodiments. In the present embodiment, the limiting portion 3 is not only used to expand the elastic expansion members 51, but also plays a limiting role on the elastic expansion members 51 to prevent the elastic portion 5 from detaching from the positioning member 4.

What is claimed is:

1. A telescopic rod comprising an inner tube and an outer tube nested with each other, wherein an end portion of the inner tube extending into the outer tube is used as an extension end, the extension end is provided with a limiting portion, a bottom portion of the limiting portion is connected to the extension end, a top portion of the limiting portion is provided with a positioning member, an outer diameter of the limiting portion gradually decreases from the bottom portion to the top portion, and the positioning member is slidably connected with an elastic portion, so that the elastic portion can reciprocate along the positioning member in the same axial direction as the inner tube; the elastic portion has elastic expansion members, and the elastic expansion members form static friction with an inner wall of the outer tube; when the inner tube and the outer tube are rotated relative to each other, the elastic expansion members move along the positioning member towards the limiting portion due to the static friction; the elastic expansion members move from the top portion of the limiting portion to the bottom portion thereof along an outer peripheral wall of the limiting portion, and the limiting portion gradually expands the elastic expansion members, so that the elastic expansion members are tightly abutted against the inner wall of the outer tube; and at this point, the inner tube and outer tubes are in a mutually locked state, and no relative axial displacement occurs between the inner tube and the outer tube; and
when the inner tube and the outer tube are rotated in opposite directions relative to each other, the outer tube drives the elastic portion to move away from the limiting portion along the positioning member, so that the elastic expansion members of the elastic portion move from the bottom portion of the limiting portion to the top portion thereof, the elastic expansion members gradually retract, the elastic expansion members and the inner wall of the outer tube are released from the tight abutting state, and at this time, the outer tube and the inner tube are in a mutually unlocked state.

2. The telescopic rod according to claim 1, wherein the elastic portion comprises a base and the elastic expansion members connected to the base, and the base is slidably connected to the positioning member.

3. The telescopic rod according to claim 2, wherein the elastic expansion members are long-strip block with a certain elastic deformation ability, a plurality of long-strip blocks are spaced apart and evenly distributed around the base, and outer walls of the long-strip blocks have a shape adapted to the inner wall of the outer tube.

4. The telescopic rod according to claim 3, wherein a plurality of spaced and evenly distributed snap-in blocks are provided around the base, a connection is formed among bottom portions of the plurality of elastic expansion members, a gap is formed between two adjacent elastic expansion members, and the snap-in blocks are snapped into the gaps between the corresponding two adjacent elastic expansion members to form a limit, so that a rotation limit is formed between the base and the plurality of elastic expansion members.

5. The telescopic rod according to claim 2, wherein the positioning member is a threaded post, and a threaded hole in slide fit with the threaded post is provided in the center of the base.

6. The telescopic rod according to claim 2, wherein a through hole is provided in the center of the limiting portion, the limiting portion is sleeved on the positioning member through the through hole, and the positioning member is provided with a first limiting ring at the through hole to prevent the limiting portion from detaching from the positioning member.

7. The telescopic rod according to claim 6, wherein a top end of the positioning member is provided with a second limiting ring to prevent the base from detaching from the positioning member.

8. The telescopic rod according to claim 1, wherein the elastic expansion members are made of plastic.

9. The telescopic rod according to claim 1, wherein the limiting portion is made of plastic.

10. A telescopic structure comprising an inner tube and an outer tube nested with each other, wherein an end portion of the inner tube extending into the outer tube is used as an extension end, the extension end is provided with a limiting portion, a positioning member is provided between a bottom portion of the limiting portion and the extension end, an outer wall of the limiting portion gradually increases from the bottom portion to a top portion thereof, and the positioning member is slidably connected with an elastic portion, so that the elastic portion can reciprocate along the positioning member in the same axial direction as the inner tube, and the limiting portion forms a limit to the elastic portion to prevent the elastic portion from detaching from the limiting portion; the elastic portion has elastic expansion members, and the elastic expansion members form static friction with an inner wall of the outer tube; when the inner tube and the outer tube are rotated relative to each other, the elastic expansion members move along the positioning member towards the limiting portion due to the static friction; the elastic expansion members move from the top portion of the limiting portion to the bottom portion thereof along an outer peripheral wall of the limiting portion, and the limiting portion gradually expands the elastic expansion members, so that the elastic expansion members are tightly abutted against the inner wall of the outer tube; and at this point, the inner tube and outer tubes are in a mutually locked state, and no relative axial displacement occurs between the inner tube and the outer tube; and
when the inner tube and the outer tube are rotated in opposite directions relative to each other, the outer tube drives the elastic portion to move away from the limiting portion along the positioning member, so that the elastic expansion members of the elastic portion move from the bottom portion of the limiting portion to the top portion thereof, the elastic expansion members gradually retract, the elastic expansion members and the inner wall of the outer tube are released from the tight abutting state, and at this time, the outer tube and the inner tube are in a mutually unlocked state.
